(19) United States
(12) Patent Application Publication
(10) Pub. No.: US 2007/0258334 A1
(43) Pub. Date: Nov. 8, 2007

(54) Botton panel for linear actuator

(75) Inventors: Hsin-An Chiang, Taichung City (TW); Yu-Chih Lin, Taichung City (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/430,563

(22) Filed: May 8, 2006

(51) Int. Cl. G04B 47/00; A61G 7/10; G04B 23/02; G08B 1/00

(52) U.S. Cl. 368/10; 368/244; 340/309.16; 5/81.1 R

(57) ABSTRACT

A button panel for linear actuator according to the present invention comprises a linear actuator for adjusting the inclination and altitude as well as horizontal displacement of an attached bed or chair, and the button panel is equipped with a linear actuator button, display, date/time/alarm setting buttons, sphygmomanometer button and thermometer button as well as a buzzer and a microprocessor inside, wherein the microprocessor has function modules corresponding to foresaid buttons which are coupled with said operating purposes respectively and conducts the display devices present the resultant values and symbols.

### BACKGROUND OF THE INVENTION

1. Field of the Invention

The present invention is related to a linear actuator, and, more particularly, to a linear actuator which is extensively adapted to a hospital bed, a facial bed or a massage chair. A button panel is provided to control said linear actuator to achieve the purposes such as adjusting the inclination and altitude as well as horizontal displacement of the objective bed or chair. This invention further increases the function of the button panel to improve the utility thereof.

2. Description of the Related Art

A conventional hospital bed as shown in FIG. 1, with a linear actuator provided under the bed and a button panel for adjusting the inclination and altitude as well as horizontal displacement of the objective bed. Foresaid linear actuator and button panel are capable of adapting to a massage chair or a facial bed also.

As illustrated in FIG. 2, foresaid button panel generally has a plurality of buttons corresponding to various desirable operating purposes such as adjusting the inclination and altitude as well as horizontal displacement of the objective bed.

### SUMMARY OF THE INVENTION

The primary objective of the present invention is to provide a multi-functioned button panel with improved practicability and conveniency. For instance, a plurality of general functions such as date/time/alarm setting and room temperature monitoring or some specific functions like taking body temperature and blood pressure are available as attached thereon.

A button panel for linear actuator of the present invention, comprises a linear actuator capable of adjusting the inclination and altitude as well as horizontal displacement of an bed or chair that it is attached to and said button panel is equipped with a linear actuator button, display, date/time/alarm setting buttons, clinical thermometer button and sphygmomanometer button as well as a buzzer and a microprocessor inside, wherein the microprocessor has date/time/alarm setting module, room temperature monitoring module, body temperature detecting module and blood pressure detecting module corresponding to foresaid buttons which are coupled with said functions respectively and conducts the resultant values or symbols to be displayed by a display device.

### BRIEF DESCRIPTION OF THE DRAWINGS

FIG. 1 is a schematic drawing showing a conventional hospital bed or facial bed elevated under control of a linear actuator.

FIG. 2 is an enlarged plain drawing of the button panel for linear actuator of FIG. 1.

FIG. 3 is a perspective view of a button panel according to the present invention.

FIG. 4 is also a perspective view of a button panel according to the present invention from an alternative viewpoint.

FIG. 5 is a schematic drawing showing a button panel displaying resultant indication with its display device according to the present invention.

FIG. 6 is a schematic drawing showing a button panel according to the present invention connected with an armband for taking blood pressure.

FIG. 7 is a schematic drawing illustrating the circuit among a button panel, a linear actuator and assemblies thereof according to the present invention.

FIG. 8 is a block diagram showing the function system of the button panel according to the present invention.

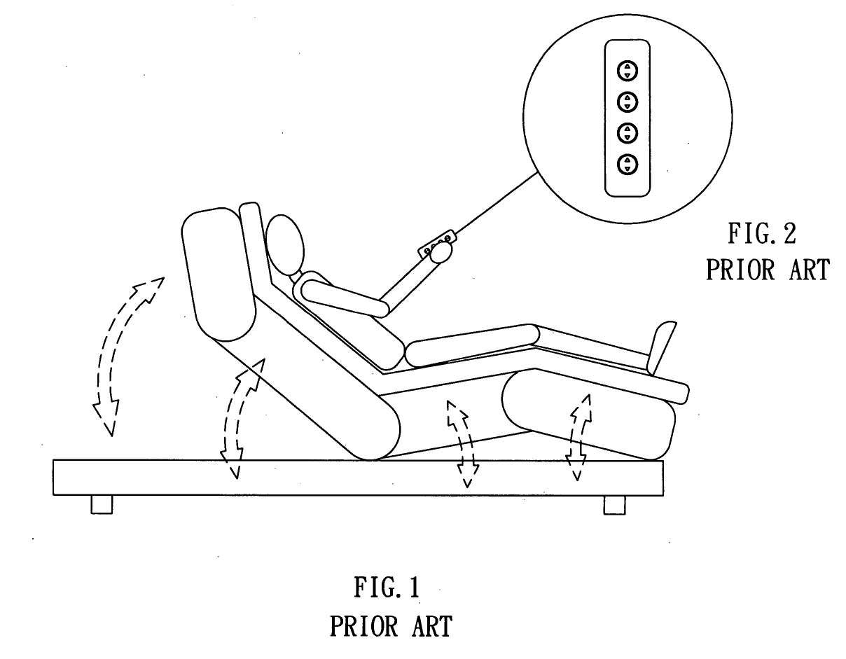

### DETAILED DESCRIPTION OF THE PREFERRED EMBODIMENTS

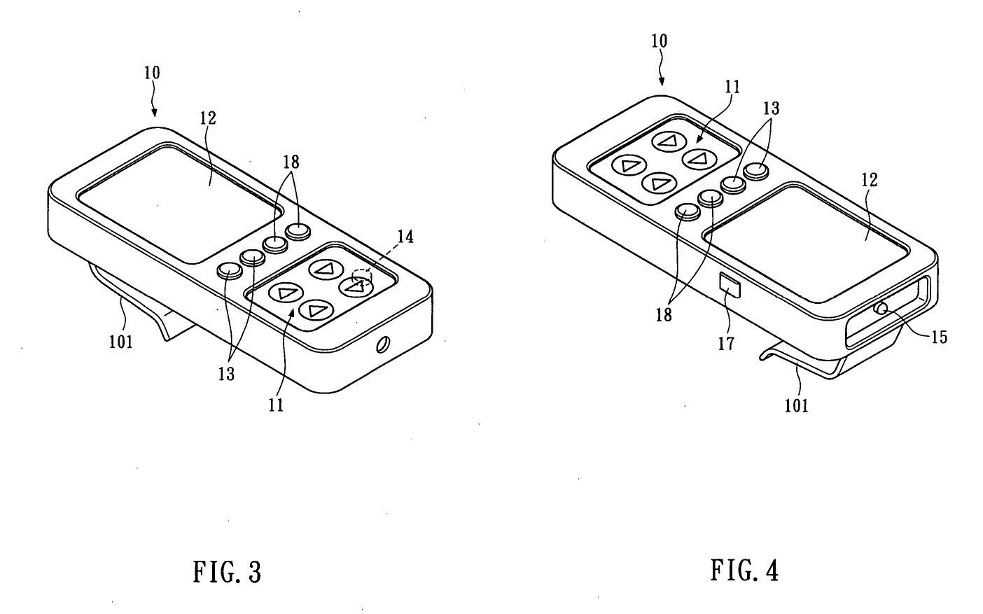

Referring to FIGS. 3, 4 and 5, a button panel 10 according to the present invention mainly implements adjustment of inclination and altitude as well as horizontal displacement of an attached bed or chair. Additionally, a plurality of general functions such as date/time/alarm setting and room temperature monitoring may also be attached. The button panel 10 is equipped with a linear actuator button 11, display device 12, date/time/alarm setting buttons 13, a buzzer 14 and a temperature sensor 15 to correspond to all the major and general functions.

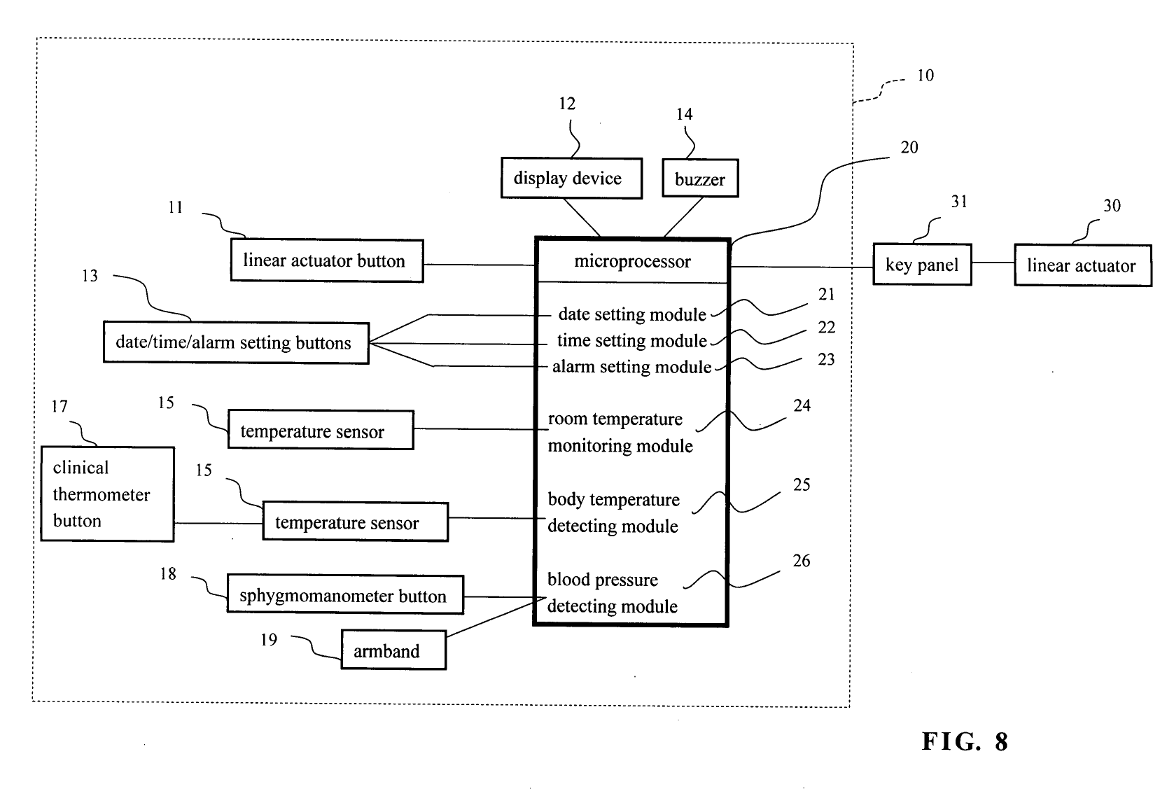

As shown in FIG. 8, a microprocessor 20 inside the button panel 10 is the central administration of receiving, managing and implementing all the instructions, information and functions.

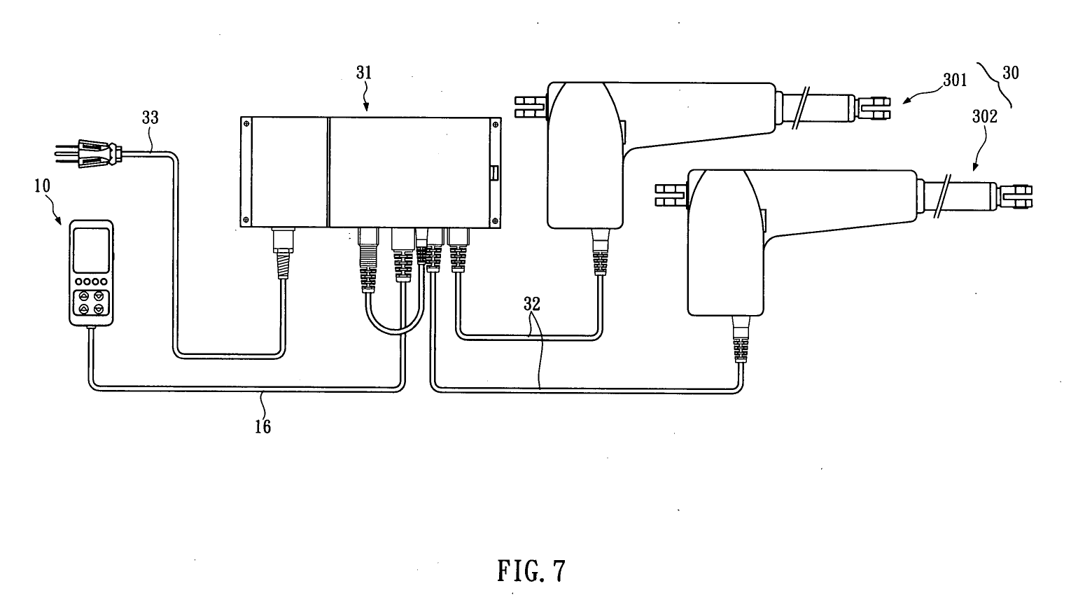

The foregoing linear actuator button 11 is provided for operating the adjustment of inclination and altitude as well as horizontal displacement of an attached bed or chair. In FIG. 7, the relationship among the linear actuator 30, control box 31 and button panel 10 is summarized. The linear actuator 30 is substantially divided into two parts, a first linear actuator 301 and a second linear actuator 302, which are respectively in charge of operating varied portions of a chair or bed where the linear actuator 30 is attached on. The two linear actuators 301, 302 are associated through an electrical transmission line 32 to a control box 31 which is further connected to a power source by a power cord 33. The button panel 10 of the present invention is coupled to the control box 31 through an electrical transmission line 16. In other words, the linear actuator of button panel 10 of the present invention sends instruction to control box 31 to further operate the linear actuator 30. And the control box 31 supplies the power to the button panel 10 by means of the electrical transmission line 16.

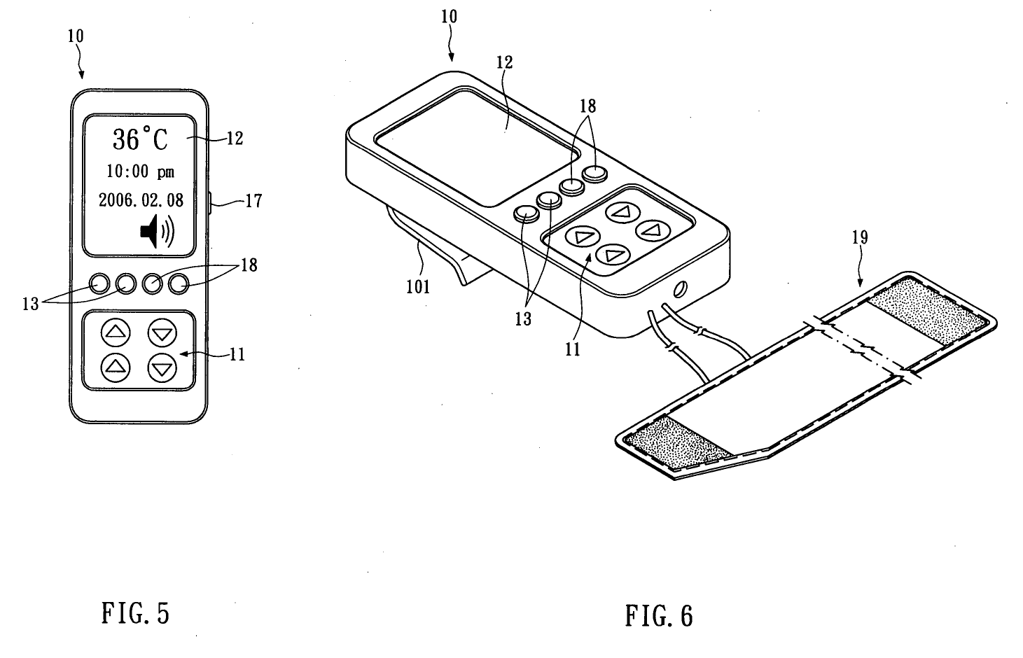

In FIG. 8, said date/time/alarm setting buttons 13 are provided for the operating the date setting module 21, time setting module 22 and alarm setting module 23 of the microprocessor. In FIG. 5, an embodiment of the button panel 12 is displaying resultant date, time and alarm symbol under the control of the microprocessor 20. In addition, the alarm sounds is given through the buzzer 14. The time setting module 22 of the microprocessor 20 allows the user pre-determining a plurality of time-points and sounds the buzzer 14 correspondingly with each pre-determined time-point.

As to foresaid temperature sensor 15, it is to detect the room temperature and pass the temperature information to the room temperature monitoring module 24 of the microprocessor 20 for finally presenting the value through the display device 12.

In addition to the major and general functions, the button panel of the present invention may further comprise particular functions such as detecting body temperature and blood pressure.

Referring to FIGS. 3, 4 and 8, in one embodiment of the present invention, the body temperature detecting function involves a clinical thermometer button 17 and a temperature sensor 15 built in the button panel 10. When the clinical thermometer button 17 is pushed down, the temperature sensor 15 obtains the body temperature by detecting the outer skin, for example, the forehead of a human and then passes the resultant value to the body temperature detecting module 25 of the microprocessor 20 for final displayed in the display device 12. The microprocessor 20 further sounds the buzzer 14 when the resultant body temperature goes higher than a pre-determined value.

As shown in FIGS. 6 and 8, the blood pressure detecting function is performed by means of a sphygmomanometer button 18 built on the button panel 10, an armband 19 and a blood pressure detecting module 26 of the microprocessor 20. As the sphygmomanometer button 18 is pushed down, the blood pressure detecting module 26 conducts inflation and deflation to the armband 19. During deflating the armband 19, the blood pressure detecting module 26 collects the values of arterial blood pressure and pulsation. Then the microprocessor 20 processes the values of arterial blood pressure to obtain the values of diastolic pressure and systolic pressure. The display device 12 finally presents the values of diastolic pressure, systolic pressure and pulsation digitally.

From FIGS. 3 and 4, we can see a clasper 101 disposed on the back surface of the button panel 10 for fixing the button panel 10 on a pre-determined position of the objective bed or chair.

The practical utility of the present invention is to integrate various functions including controlling a linear actuator, setting and revealing date/time/alarm information, monitoring room temperature, detecting and demonstrating body temperature as well as detecting and demonstrating blood pressure and into one button panel 10. When the button panel of the present invention is, for example, applied to a hospital bed, a healthcare worker or a patient may use the button panel to collect values of body temperature and blood pressure without brining a sphygmomanometer or thermograph to the bedside. While applying the date/time/alarm function, a healthcare worker or a patient can be reminded of a waiting work such as taking medicine, taking temperature, blood pressure or changing dressings by the buzzing buzzer at a pre-set time point.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompasses all such modification and similar arrangements and procedures.

What the invention claimed is:

1. A button panel for linear actuator which comprises a linear actuator capable of adjusting the inclination and altitude as well as horizontal displacement of an attached bed or chair and a linear actuator button for operating said linear actuator; wherein the button panel further includes:
a display device;
a microprocessor;
a date setting button for operating the date setting module of said microprocessor which subsequently conducts the display device to present set date information;
a time setting button for operating the time setting module of said microprocessor which subsequently conducts the display device to present set date information;
an alarm setting button for the user to operate the alarm setting module of said microprocessor which subsequently conducts the display device to present an alarm symbol after setting;
a buzzer, which is driven to buzz by the alarm setting module of said microprocessor.

2. The button panel for linear actuator as claimed in claim 1, wherein, the microprocessor associated with the button panel further comprises a room temperature monitoring module which detects the room temperature by mean of a room temperature sensor equipped on the button panel and conducts the display device to present the resultant room temperature.

3. The button panel for linear actuator as claimed in claim 2, wherein, the microprocessor associated with the button panel further comprises a body temperature detecting module which collects the body temperature by mean of a body temperature sensor and a body temperature detecting button provided on the button panel and conducts the display device to reveal the resultant body temperature.

4. The button panel for linear actuator as claimed in claim 3, wherein, the microprocessor drives the buzzer to buzz when the resultant body temperature collected by body temperature detecting module goes higher than a predetermined value.

5. The button panel for linear actuator as claimed in claim 3, wherein, the microprocessor further comprises a blood pressure detecting module which collects the values of pulsation and blood pressure by means of a sphygmomanometer button built on the button panel and an armband coupled therewith and further conducts the display device showing the values of pulsation and blood pressure.
